(19) United States
(12) Patent Application Publication
(10) Pub. No.: US 2004/0198428 A1
(43) Pub. Date: Oct. 7, 2004

(54) Miniature, high efficiency antenna device for enabling wireless communication with a computer system

(75) Inventors: Jing-Qing Hong, Taipei Hsien (TW); Yu-Shun Qiu, Taipei Hsien (TW)

Correspondence Address: BACON & THOMAS, PLLC, 625 SLATERS LANE, FOURTH FLOOR, ALEXANDRIA, VA, 22314

(73) Assignee: KYE SYSTEMS CORP., Taipei Hsien (TW)

(21) Appl. No.: 10/157,925

(22) Filed: May 31, 2002

(51) Int. Cl. H04B 1/38

(52) U.S. Cl. 455/556.1; 343/702; 455/129; 455/550.1

(57) ABSTRACT

An antenna device arranged to facilitate communications within a computer system includes a core wound with an antenna thereon, the antenna further being connected with an electronic board. The core has a high magnetic permeability so as to increase the magnetic field intensity and enhance the efficiency of the antenna device. The wound-core antenna can dramatically reduce the length of the antenna so as to enable the device to fit into a miniature wireless device.

### FIELD OF THE INVENTION

The present invention relates to an antenna device, and particularly to an antenna device having reduced size to enable the antenna to be mounted in a wireless input/output device such as a computer mouse or keyboard, for enabling wireless communications between the wireless input/output device and a host computer.

### BACKGROUND OF THE INVENTION

As is well-known, antenna devices are necessary for wireless communication facilities to receive and transmit signals. In general, such antennas are made up of a conductor whose length is determined by wavelengths of the signals to be transmitted or received. However, the wavelength limitation presents problems in the case of wireless computing equipment, in which space is at a premium. In that case, it is known to for the antenna as a coil, in order to reduce the space occupied by the antenna.

The present invention also utilizes an antenna coil, but with the added feature of a solid, magnetically permeable core. The magnetically-permeable core increases the efficiency of the antenna device without increasing the antenna's footprint, thereby making the antenna especially suitable for enabling communication between a host computer and its peripherals.

It is of course known to include wireless receivers, transmitters, or transceivers in a host computer and in peripherals and other devices such as computer mouses, keyboards, game pads, and the like that must communicate with the host computer. However, the known antenna is usually printed on a printed circuit board (PCB), or is simply formed by using a metal wire instead. Such an antenna will still occupy a large space within a wireless device, and thus the device cannot be made as small as possible.

U.S. Pat. No. 5,854,621 discloses a closed loop antenna printed on a PCB mainly along the peripheral of the wireless device to form an enclosed space. While such antennas may be highly efficient, the ability of the antenna to receive appropriate signals is dependent on the area of the loop, which in turn may limit the size of the peripheral device in which the antenna is situated.

Another example of a conventional loop antenna is shown in U.S. Pat. No. 6,138,050. As disclosed therein, the problem of space occupied by this antenna is solved by extending the antenna along the periphery of a keyboard to increase the area of the loop, and by connecting the loop antenna with a metal plate to close the loop, resulting in a structure that is difficult to implement.

Finally, International Patent Publication WO02-07260, discloses a printed antenna that is further connected with a three-dimensional antenna loop within a wireless input device. This antenna also occupies a relatively large space inside of the device in which it is positioned, limiting further miniaturization of the device.

### SUMMARY OF THE INVENTION

It is accordingly a primary objective of the present invention is to provide an antenna device that is efficient enough to enable transmission or reception of signals typical of communications within a computer system, and yet that is sufficiently small to meet demands for miniaturization of computer system components.

According to the present invention, the antenna device is formed by an antenna coil wrapped around a magnetically permeable core, with one or both ends of the antenna being connected to an electronic board within a host computer or corresponding peripheral device to enable communications between the host computer and the peripheral device (or, more generally, between any two devices in a computer system).

The magnetically permeable core may have a variety of shapes and sizes, including by way of example and not limitation, round, square, solid, or hollow bar shapes, and may be made of any suitable magnetically permeable material including, by way of example and not limitation, ferrite. In addition, the antenna may be made of copper or a similarly conductive material.

The various objects and advantages of the present invention will be more readily understood from the following detailed description when read in conjunction with the appended drawing.

### BRIEF DESCRIPTION OF THE DRAWINGS

FIG. 1A is a perspective view of the antenna according to the first embodiment of the present invention.

FIG. 1B is a perspective view of the antenna according to the second embodiment of the present invention.

FIG. 2A is a perspective view of the antenna according to the third embodiment of the present invention.

FIG. 2B is a perspective view of the antenna according to the fourth embodiment of the present invention.

FIG. 3 is a perspective view of the antenna according to the fifth embodiment of the present invention.

FIG. 4 is a perspective view of the antenna according to the present invention as applied to a computer mouse.

FIG. 5 is a perspective view of the antenna according to the present invention as applied to a computer keyboard.

FIG. 6 is a functional block diagram showing an example of a system of carrying out wireless communication between a computer system and a computer peripheral device utilizing the antenna of the invention\

### DETAILED DESCRIPTION OF THE PREFERRED EMBODIMENTS

In general, the antenna of the invention is in the form of a winding wrapped around a magnetically permeable core. The core may, for example, be made of ferrite or a similar material, and is part of the antenna device installed within a wireless pointing device, wireless input device, wireless output device, wireless receiver, or transceiver, for use in a host computer or in a computer peripheral or electronic device such as a computer mouse, keyboard, or PC camera etc. The core is used to increase the magnetic field intensity and promotes the efficiency of an antenna device. As a result, the length and volume of the antenna can be dramatically reduced to fit into a miniaturized computer-communicating device.

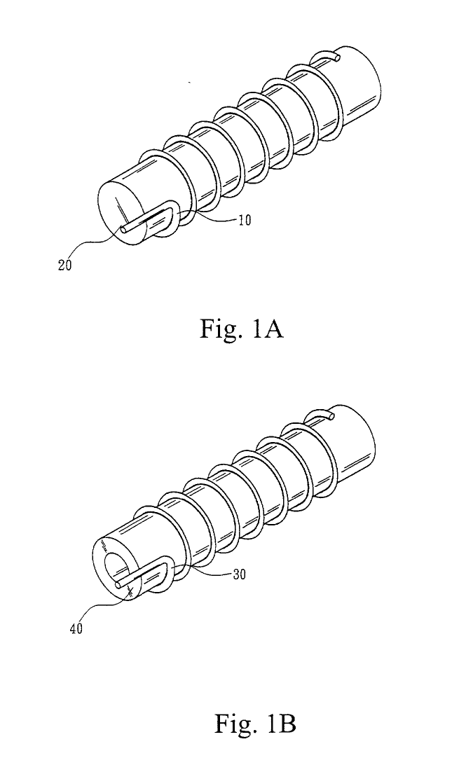

The first embodiment seen in FIG. 1A has a core 20 wound with an antenna 10. The length of the antenna 10 depends on the bandwidth of the wireless communicating device, in which it is utilized, and whether the antenna is a single pole or dipole antenna. In general, according to principles well-known in the wireless transmission are, the length of the antenna depends on ¼ or n+¼ multiples of the center wavelength to be received or transmitted, where n is an integer. In order to minimize the length of the antenna, the preference is for a length of about ¼ of the wavelength.

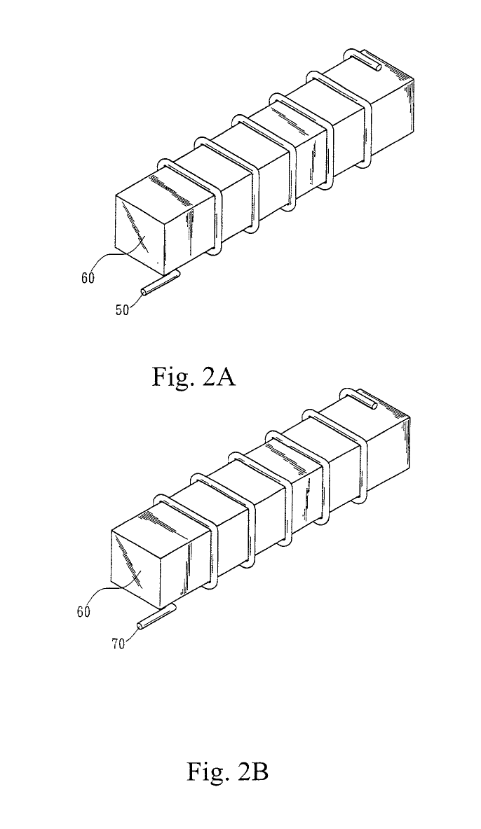

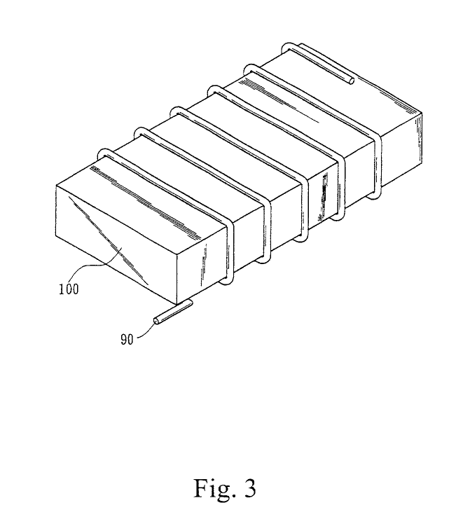

Referring to FIG. 1B, the core may be in the shape of a cylinder or other hollow solid without loss of efficiency. In practical usage, the shape of the core is not limited to round, square, solid or hollow bars, examples of which are illustrated in FIG. 2A, which shows a square core 60 wound with antenna 50; FIG. 2B, which shows a hollow square core 80 wound with antenna 70; and FIG. 3, which shows a flat square core 100 winded with antenna 90.

Those skilled in the art will appreciate that although the winding direction of the antenna corresponding to the illustrated cores may either be clockwise or anti-clockwise according to practical conditions, and that the antenna may be made of a variety of suitable conductive materials, including but not limited to copper.

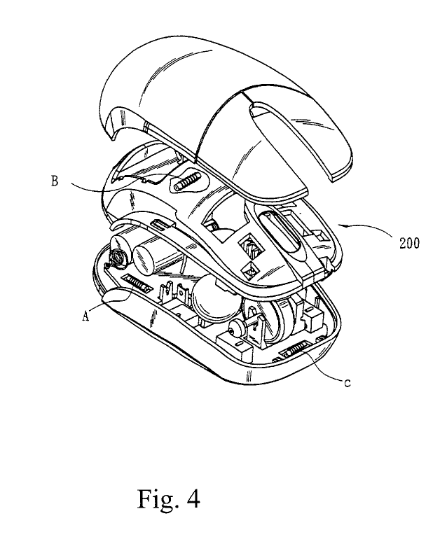

Please refer to FIG. 4 showing a practical use in a computer mouse 200. The antenna-wound core can be located at position A, B or C, since the core only occupies a small internal space of the mouse.

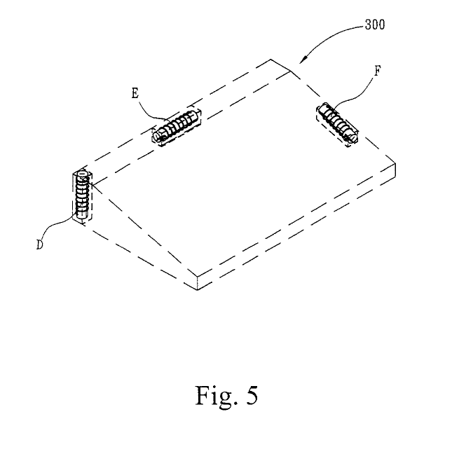

Please refer to FIG. 5 showing another practical use in a computer keyboard 300. Again, the wound core antenna can be located at a number of positions A, B or C, because the core only occupies a small internal space of the keyboard.

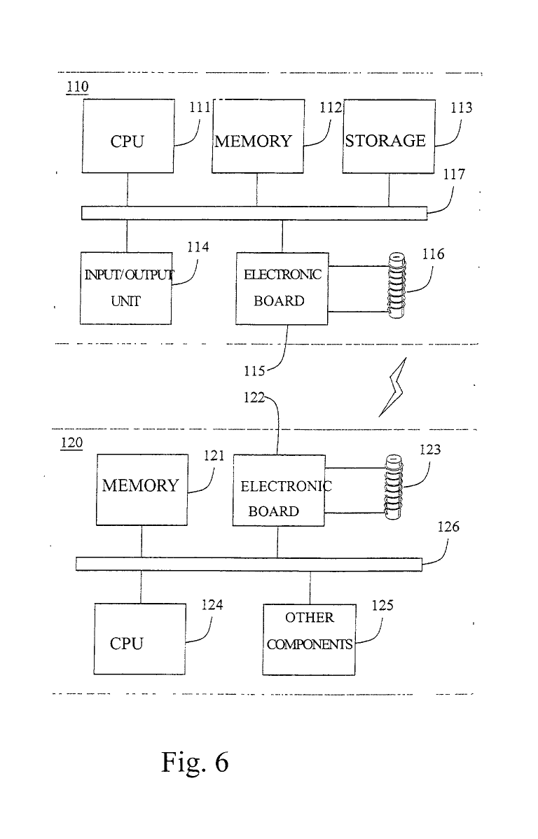

Please refer to FIG. 6 showing a wireless interconnection between a computer 110 and a peripheral device 120. The peripheral device 120 has an electronic board 122 (such as a wireless transmitter or transceiver board) arranged to transmit communication signals via antenna 123 to computer 110. The computer 110 also has an electronic board 115 (such as a wireless receiver or transceiver board) arranged to receive the communication signals via antenna 116. Conversely, communication signals sent by the computer system 110 are also received by the peripheral device 120.

As illustrated in FIG. 6, both ends of the preferred antenna 116 (or 123) are connected with the electronic board 115 (or 122) so as to form an antenna loop. However, those skilled in the art will appreciate that just one end of the antenna 116 (123) may be connected with the electronic board 115 (or 122) when an amplifying circuit (not shown) is located at board 115 (or122).

The computer system 110 of FIG. 6 has a CPU 111 to store commands in memory 112 via data bus 117 in order to save information in storage 113. The CPU 111 commands input/output unit 114 to receive an input, and then outputs information via data bus 117 so as to send wireless signals generated by the electronic board 115 via the antenna device 116.

The peripheral device 120 also has a CPU 124 to store commands in memory 121 via data bus 126, the CPU 124 commanding other components 125 to output information via data bus 126 so as to send wireless signals generated by the electronic board 122 from the antenna device 123. Either the computer system 110 or the peripheral device 120 is a known skill in the state art.

Pursuant thereto, the present invention easily fits into a minimized wireless device; no matter whether it is installed in connection with a transceiver, receiver or a transmitter.

Having thus described the present invention in sufficient detail to enable those skilled in the art to make and use the invention, it nevertheless should be appreciated that the preferred embodiments may be varied in many ways. Such variations are not to be regarded as a departure from the spirit and scope of the present invention, and all such modifications as would be obvious to one skilled in the art are intended to be included within the scope of the following claims.

What is claimed is:

1. An antenna device arranged to enable wireless communications between devices in a computer system, comprising:
a core;
an antenna wound around a surface of the core;
wherein the antenna further connects with an electronic board that enables the board to receive or transmit a wireless communication signal.

2. The antenna device as claimed in claim 1, wherein one end of the antenna is coupled to the board and the board has an amplifying circuit thereon.

3. The antenna device as claimed in claim 1, wherein both ends of the antenna are respectively coupled to the board y to form an antenna loop.

4. The antenna device as claimed in claim 1, wherein the electronic board is a transceiver.

5. The antenna device as claimed in claim 1, wherein the electronic board is a receiver.

6. The antenna device as claimed in claim 1, wherein the electronic board is a transmitter.

7. The antenna device as claimed in claim 1, wherein the shape of the core is selected from the group consisting of a round bar, a square bar, and a hollow bar.

8. The antenna device as claimed in claim 1, wherein the core is a ferrite core.

9. The antenna device as claimed in claim 1, wherein the antenna device is located within a wireless input device.

10. The antenna device as claimed in claim 1, wherein the antenna device is located within a wireless receiver.

11. The antenna device as claimed in claim 1, wherein the antenna device is located within a computer.

12. The antenna device as claimed in claim 1, wherein the antenna is made of copper.
